(19) United States
(12) Patent Application Publication
(10) Pub. No.: US 2025/0328174 A1
(43) Pub. Date: Oct. 23, 2025

(54) HYPERBARIC THERMAL ARCHITECTURE FOR AN INFORMATION HANDLING SYSTEM

(71) Applicant: DELL PRODUCTS L.P., Round Rock, TX (US)

(72) Inventors: Jean Doglio, Round Rock, TX (US); Jon Isom, Austin, TX (US); Timothy Radloff, Austin, TX (US)

(21) Appl. No.: 18/638,109

(22) Filed: Apr. 17, 2024

(51) Int. Cl. G06F 1/20

(52) U.S. Cl. CPC G06F 1/203; G06F 2200/201

(57) ABSTRACT

An information handling system includes a pressurized zone, a non-pressurized zone, a printed circuit board assembly (PCBA), a cooling fan, and a sealing component. The pressurized and non-pressurized zones combine to form a hyperbaric thermal architecture for the information handling system. The PCBA is located within the pressurized zone. The cooling fan is located within the non-pressurized zone. The cooling fan provides an airflow into the pressurized zone and across the PCBA. The sealing component is located along an intersection of the pressurized zone and the non-pressurized zone. A portion of the cooling fan is in physical communication with the sealing component.

### FIELD OF THE DISCLOSURE

The present disclosure generally relates to information handling systems, and more particularly relates to a hyperbaric thermal architecture for an information handling system.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system includes a pressurized zone, a non-pressurized zone, a printed circuit board assembly (PCBA), a cooling fan, and a sealing component. The pressurized and non-pressurized zones combine to form a hyperbaric thermal architecture for the information handling system. The PCBA may be located within the pressurized zone. The cooling fan may be located within the non-pressurized zone. The cooling fan may provide an airflow into the pressurized zone and across the PCBA. The sealing component may be located along an intersection of the pressurized zone and the non-pressurized zone. A portion of the cooling fan may be in physical communication with the sealing component.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a perspective view of an information handling system according to at least one embodiment of the present disclosure; and

FIGS. 2-6 are diagrams of different embodiments of hyperbaric thermal architectures of an information handling system according to at least one embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

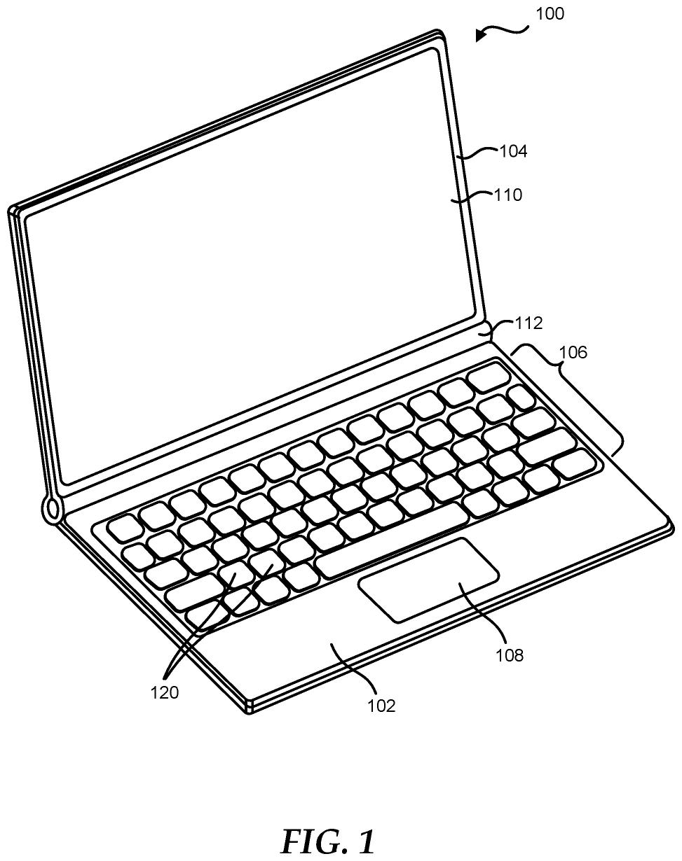

FIG. 1 illustrates an information handling system 100 according to at least one embodiment of the present disclosure. For purposes of this disclosure, an information handling system can include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (such as a desktop or laptop), tablet computer, mobile device (such as a personal digital assistant (PDA) or smart phone), server (such as a blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

Information handling system 100 includes a base portion 102 and a top 104. Base portion 102 includes a keyboard 106 and a touchpad 108, and top portion 104 includes a display device 110. In an example, touchpad 108 may be any suitable pointing device. Base portion 102 is connected top portion 104 via a mechanism 112, such as one or more hinges. Keyboard 106 includes multiple keys 120. When the information handling system 100 comprises a 2-in-1 device, mechanism 112 may enable the top portion 104 to be connected to base portion 102 for use as a laptop device and may enable the top portion 104 to be detached from base portion 102 to enable the top portion 104 to be used as a tablet information handling system. Display device 110 may include one or more light emitting devices, such as, for example, light emitting diodes (LEDs), organic LED (OLED), liquid crystal display (LCD), another type of light emitting device, or any combination thereof.

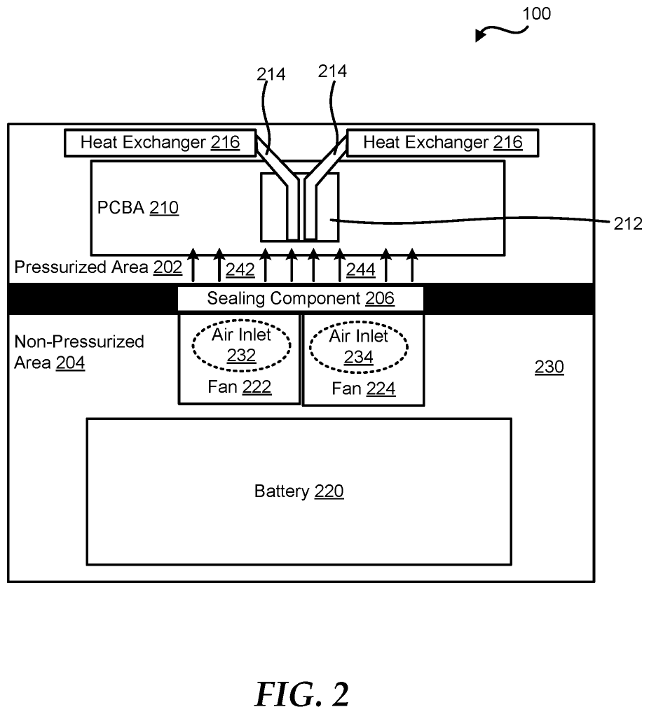

FIG. 2 illustrates information handling system 100 with a dual cooling fan hyperbaric thermal architecture according to at least one embodiment of the present disclosure. Base portion 102 of information handling system 100 includes a pressurized area 202, a non-pressurized area 204, and a sealing component 206. Within pressurized area 202, information handling system 100 further includes a printed circuit board assembly (PCBA) 210, a heat removal plate 212, heat pipes 214, and heat exchangers 216. Within non-pressurized area 204, information handling system 100 further includes a battery 220, and cooling fans 222 and 224. The formation of pressurized area 202 and non-pressurized area 204 to create a hyperbaric thermal architecture is known in the art and will not be further disclosed herein, except as needed to illustrate the various embodiments disclosed herein. Information handling system 100 may include additional components without varying from the scope of this disclosure.

In an example, battery 220 may be located in the front portion of non-pressurized area 204 with cooling fans 222 and 224 may be located in the back portion of the non-pressurized area. Battery 220 may be any suitable shape and size as will be described herein. For example, battery 220 may be a rectangular shape, such that the battery does not extend beyond the front edges of cooling fans 222 and 224. In this example, the front edges of cooling fans 222 and 224 may be the edges that are farthest from sealing component 206.

Based on battery 220 not extending beyond front edges of cooling fans 222 and 224, no portion of the battery is closer to sealing component 206 than any portion of the cooling fans. In this example, cooling fans 222 and 224 may be located in between battery 220 and PCBA 210. In certain examples, a portion of each of cooling fans 222 and 224 may be located under and in physical communication with sealing component 206. Based on the portion of each of cooling fans 222 and 224 being located in front of sealing component 206, the cooling fans 222 and 224 may provide respective airflows 242 and 244 into pressurized area 202.

In certain examples, sealing component 206 may create a seal across the entire length of base portion 102 between pressurized area 202 and non-pressurized 204. In an example, keyboard 106 of FIG. 1 may be on a translating tray, such that the tray may enable the keyboard to slide into place over non-pressurized area 204 of base portion 102. In this example, sealing component 206 may be located between the keyboard tray and a surface created by a flange on a chassis structural wall and the tops of cooling fans 222 and 224. In certain examples, the chassis structural wall may be an unbroken/continuous structural wall, such that the wall and cooling fans 222 and 224 may seal with a bottom surface 230 of base portion 102 to create a division between pressurized area 202 and non-pressurized area 204. In an example, sealing component 206 may be any suitable component, such as a gasket that is formed from foam covered with mylar. In certain examples, additional sealing components may be utilized to seal around input/output (I/O) connectors of PCBA 210 to further create pressurized area 202.

In an example, base portion 102 also includes a bottom surface 230 that extends below both pressurized area 202 and non-pressurized area 204. In certain examples, information handling system 100 includes air inlets 232 and 234 within bottom surface 230. In an example, air inlet 232 may be located in bottom surface 230 below cooling fan 222. Similarly, air inlet 234 may be located in bottom surface 230 below cooling fan 224. Air inlets 232 and 234 may enable cooling fans 222 and 224 to pull ambient air into information handling system 100. In an example, cooling fan 222 is not sealed to air inlet 232, and cooling fan 224 is not sealed to air inlet 234. In certain examples, additional air inlets may be anywhere in non-pressurized area 204 including, but not limited to, the front, the sides, the top/keyboard, or the like of base portion 102.

In an example, cooling fan 222 may pull ambient air through air inlet 232 and provide the ambient air directly into pressurized area 202. For example, cooling fan 222 may provide airflow 242 into pressurized 202 and across PCBA 210. Cooling fan 224 may pull ambient air through air inlet 234 and provide the ambient air directly into pressurized area 202. For example, cooling fan 224 may provide airflow 244 into pressurized 202 and across PCBA 210. In an example, sealing component 206 may prevent airflows 242 and 244 from being recirculated from pressurized area 202 to non-pressurized 204.

In certain examples, as airflows 232 and 234 travel across PCBA 210 and heat removal plate 212, heat may be removed from a CPU and other components on PCBA 210. In an example, the heat may be transferred from heat removal plate 212 to heat exchangers 216 via heat pipes 214. Airflows 242 and 244 may travel through heat exchangers 216 and out of pressurized area 202 via one or more air outlets. In certain examples, air outlets of pressurized area 202 may be located at different locations, such as a back wall, side walls, a top surface, bottom surface 230, or the like.

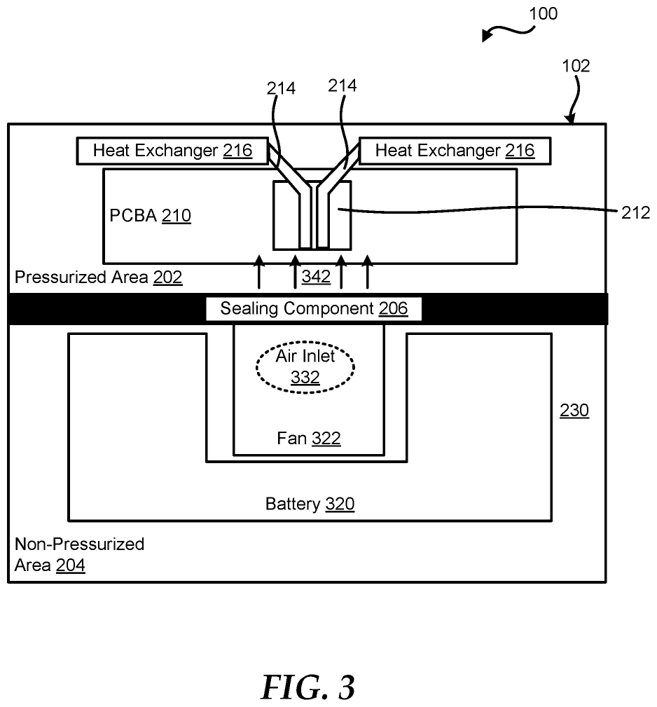

FIG. 3 illustrates information handling system 100 with a single cooling fan hyperbaric thermal architecture according to at least one embodiment of the present disclosure. Base portion 102 of information handling system 100 includes pressurized area 202, non-pressurized area 204, and sealing component 206. Within pressurized area 202, information handling system 100 further includes PCBA 210, heat removal plate 212, heat pipes 214, and heat exchangers 216. Within non-pressurized area 204, information handling system 100 further includes a battery 320 and a cooling fans 322. Information handling system 100 may include additional components without varying from the scope of this disclosure. Information handling system 100 in the single cooling fan hyperbaric thermal architecture may include additional components without varying from the scope of this disclosure.

In certain examples, battery 320 may be located in the front portion of non-pressurized area 204 with a couple of portions that extend toward sealing component 206. Cooling fan 322 may be located in the back portion of the non-pressurized area. In an example, battery 320 may be a ‘u’ shape, such that a main portion of the battery is in front of cooling fan 322 and main extend from side to side of base portion 102. In this example, portions of the battery may extend beyond the front edge of cooling fan 322 and be located near sealing component 206. The front edge of cooling fan 322 may be the edge that is farthest from sealing component 206. Based on portions of battery 320 extending beyond front edge of cooling fan 322, these portions of the battery are closer to sealing component 206 than some portions of the cooling fan. Even though some portions of battery 320 are closer to sealing component 206, the main portion of the battery is farther from sealing component than all portions of cooling fan 322. In certain examples, a connecting board of battery 320 may be farther from sealing component 206 than all portions of cooling fan 322, while side portions of the battery may be closer to the sealing component. In this example, cooling fan 322 may be located in between the main portion of battery 320 and PCBA 210. In certain examples, a portion of cooling fan 222 may be located under and in physical communication with sealing component 206. Based on the portion of each of cooling fan 322 being located in front of sealing component 206, the cooling fan may provide an airflow 342 into pressurized area 202.

In certain examples, sealing component 206 may create a seal across the entire length of base portion 102 between pressurized area 202 and non-pressurized 204 and create the seal with a surface created by a flange on a chassis structural wall and the top of cooling fan 322 as described above with respect to FIG. 2. In an example, base portion 102 also includes bottom surface 230 that extends below both pressurized area 202 and non-pressurized area 204. In certain examples, information handling system 100 includes an air inlet 332 within bottom surface 230. In an example, air inlet 332 may be located in bottom surface 230 below cooling fan 322. Air inlet 332 may enable cooling fan 322 to pull ambient air into information handling system 100. In an example, cooling fan 222 is not sealed to air inlet 232, and cooling fan 224 is not sealed to air inlet 234. In certain examples, additional air inlets may be anywhere in non-pressurized area 204 including, but not limited to, the front, the sides, the top/keyboard, or the like of base portion 102.

In an example, cooling fan 322 may pull ambient air through air inlet 332 and provide the ambient air directly into pressurized area 202. For example, cooling fan 332 may provide airflow 342 into pressurized 202 and across PCBA 210. In an example, sealing component 206 may prevent airflow 342 from being recirculated from pressurized area 202 to non-pressurized 204.

In certain examples, as airflow 342 travels across PCBA 210 and heat removal plate 212, heat may be removed from a CPU and other components on PCBA 210. In an example, the heat may be transferred from heat removal plate 212 to heat exchangers 216 via heat pipes 214. Airflow 342 may travel through heat exchangers 216 and out of pressurized area 202 via one or more air outlets. In certain examples, air outlets of pressurized area 202 may be located at different locations, such as a back wall, side walls, a top surface, bottom surface 230, or the like.

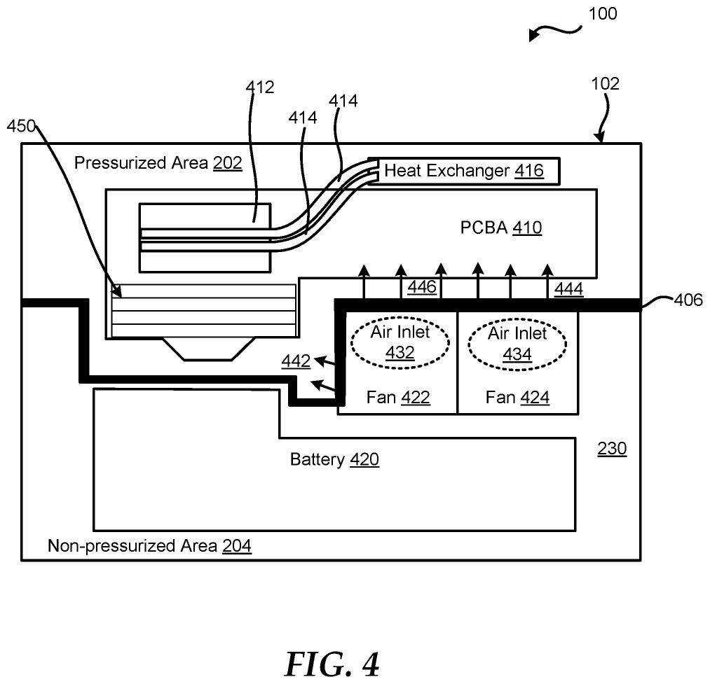

FIG. 4 illustrates information handling system 100 with a dual offset cooling fan hyperbaric thermal architecture according to at least one embodiment of the present disclosure. Base portion 102 of information handling system 100 includes pressurized area 202, non-pressurized area 204, and a sealing component 406. Within pressurized area 202, information handling system 100 further includes a PCBA 410, a heat removal plate 412, heat pipes 414, and a heat exchanger 416. Within non-pressurized area 204, information handling system 100 further includes a battery 420, and cooling fans 422 and 424. In an example, PCBA 410 may include socketed memory 450, such that the PCBA may be in a shape other than rectangle. For example, socketed memory 450 on PCBA 410 may extend towards the front of information handling system as illustrated in FIG. 4. Information handling system 100 may include additional components without varying from the scope of this disclosure.

In an example, battery 420 may be located in the front portion of non-pressurized area 204 with cooling fans 422 and 424 located in the back portion of the non-pressurized area. Battery 420 may be an ‘L’ shape, such that one portion of the battery extends farther toward sealing component 406 as compared to a main portion of the battery. In this example, the extension portion may extend beyond the front edges of cooling fans 422 and 424. In an example, the front edges of cooling fans 422 and 424 may be the edges that are nearest to the front edge of information handling system 100.

Based on the shape of battery 420, only the extension portion of the battery may be closer to sealing component 406 than any portion of the cooling fans. In this example, cooling fans 422 and 424 may be located in between the main portion of battery 420 and PCBA 210. In certain examples, portions of each of cooling fans 422 and 424 may be located under and in physical communication with sealing component 206. Based on the portions of each of cooling fans 422 and 424 being located in front of sealing component 206, the cooling fans 422 and 424 may provide respective airflows 442, 446 and 444 into pressurized area 202.

In certain examples, sealing component 406 may create a seal in base portion 102 between pressurized area 202 and non-pressurized 204. In an example, sealing component 406 may include multiple portions that extend laterally across base portion 102, and multiple portions that extend horizontally within the base portion as illustrated in FIG. 4. In this example, a few of the horizontal portions and a few of the lateral portions may cause a section of sealing component 406 to extend toward the front of information handling system 100. This section may be designed to fit around socketed memory 450 of PCBA 410. In certain examples, sealing component 406 may seal with the chassis structural wall and cooling fans 422 and 424 to create a division between pressurized area 202 and non-pressurized area 204. In an example, sealing component 406 may be any suitable component, such as a gasket that is formed from foam covered with mylar. In certain examples, additional sealing components may be utilized to seal around I/O connectors of PCBA 410 to further create pressurized area 202.

In an example, base portion 102 also includes bottom surface 230 that extends below both pressurized area 202 and non-pressurized area 204. In certain examples, information handling system 100 in the dual offset cooling fan hyperbaric thermal architecture includes air inlets 432 and 434 within bottom surface 230. In an example, air inlet 432 may be located in bottom surface 230 below cooling fan 422. Similarly, air inlet 434 may be located in bottom surface 230 below cooling fan 424. Air inlets 432 and 434 may enable cooling fans 422 and 424 to pull ambient air into information handling system 100. In an example, cooling fan 422 is not sealed to air inlet 432, and cooling fan 424 is not sealed to air inlet 434. In certain examples, additional air inlets may be anywhere in non-pressurized area 204 including, but not limited to, the front, the sides, the top/keyboard, or the like of base portion 102.

In an example, cooling fan 422 may pull ambient air through air inlet 432 and provide the ambient air directly into pressurized area 202. For example, cooling fan 422 may provide airflows 442 and 446 into pressurized 202 and across PCBA 210. In an example, airflow 442 may be in a direction toward socketed memory 450 of PCBA 410, and airflow 446 may be a different direction that is across PCBA 410 and through heat exchanger 416. Cooling fan 424 may pull ambient air through air inlet 434 and provide the ambient air directly into pressurized area 202. For example, cooling fan 424 may provide airflow 444 into pressurized 202 and across PCBA 410 in the same direction as airflow 446 from cooling fan 422. In an example, sealing component 406 may prevent airflows 442, 444, and 446 from being recirculated from pressurized area 202 to non-pressurized 204.

In certain examples, as airflows 442, 444, and 446 travel across PCBA 410 and heat removal plate 412, heat may be removed from a CPU and other components on PCBA 410. In an example, the heat may be transferred from heat removal plate 412 to heat exchanger 416 via heat pipes 414. Airflows 444 and 446 may travel through heat exchanger 416 and out of pressurized area 202 via one or more air outlets. In certain examples, air outlets of pressurized area 202 may be located at different locations, such as a back wall, side walls, a top surface, bottom surface 230, or the like.

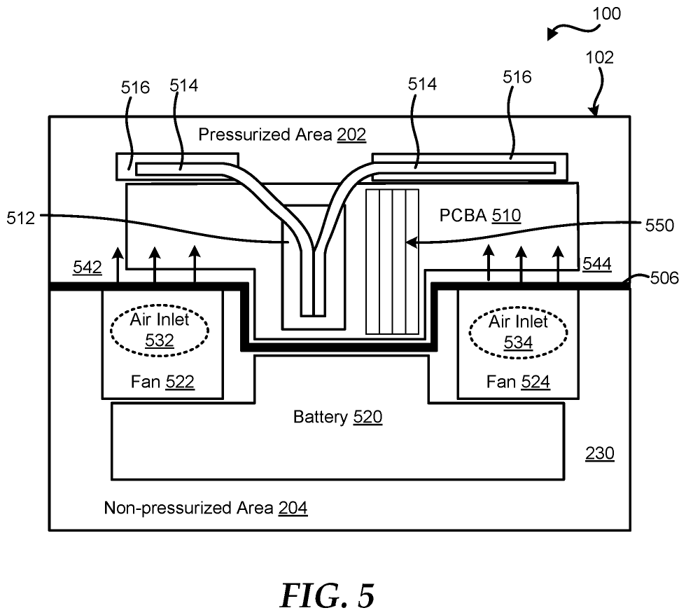

FIG. 5 illustrates information handling system 100 with a dual split cooling fan hyperbaric thermal architecture according to at least one embodiment of the present disclosure. Base portion 102 of information handling system 100 includes pressurized area 202, non-pressurized area 204, and a sealing component 506. Within pressurized area 202, information handling system 100 further includes a PCBA 510, a heat removal plate 512, heat pipes 514, and heat exchangers 516. Within non-pressurized area 204, information handling system 100 further includes a battery 520, and cooling fans 522 and 524. In an example, PCBA 510 may include socketed memory 550, such that the PCBA may be in a shape other than rectangle. For example, socketed memory 550 on PCBA 510 may extend towards one side of information handling system as illustrated in FIG. 5. Information handling system 100 may include additional components without varying from the scope of this disclosure.

In an example, battery 520 may be located in the front portion of non-pressurized area 204 with cooling fans 522 and 524 located in the back portion of the non-pressurized area. Battery 520 may be an ‘T’ shape, such that a middle portion of the battery extends farther toward sealing component 506 as compared to a main portion of the battery. In this example, the extension portion may extend beyond the front edges of cooling fans 522 and 524. In an example, the front edges of cooling fans 522 and 524 may be the edges that are nearest to the front edge of information handling system 100.

Based on the shape of battery 520, only the extension portion of the battery may be closer to sealing component 506 than any portion of the cooling fans. In this example, cooling fans 522 and 524 may be located in between the main portion of battery 520 and PCBA 510. In an example, cooling fan 522 may be located near one edge of base portion 102 and cooling fan 524 may be located near the other edge. In certain examples, portions of each of cooling fans 522 and 524 may be located under and in physical communication with sealing component 506. Based on the portions of each of cooling fans 522 and 524 being located in front of sealing component 506, the cooling fans 522 and 524 may provide respective airflows 542 and 544 into pressurized area 202.

In certain examples, sealing component 506 may create a seal in base portion 102 between pressurized area 202 and non-pressurized 204. In an example, sealing component 506 may include multiple portions that extend laterally across base portion 102, and multiple portions that extend horizontally within the base portion as illustrated in FIG. 5. In this example, one of the horizontal portions and a couple of the lateral portions may cause a middle section of sealing component 506 to extend toward the front of information handling system 100. This section may be designed to fit around socketed memory 550 of PCBA 510. In certain examples, sealing component 506 may seal with the chassis structural wall and cooling fans 522 and 524 to create a division between pressurized area 202 and non-pressurized area 204. In an example, sealing component 506 may be any suitable component, such as a gasket that is formed from foam covered with mylar. In certain examples, additional sealing components may be utilized to seal around I/O connectors of PCBA 510 to further create pressurized area 202.

In an example, base portion 102 also includes bottom surface 230 that extends below both pressurized area 202 and non-pressurized area 204. In certain examples, information handling system 100 in the dual split cooling fan hyperbaric thermal architecture includes air inlets 532 and 534 within bottom surface 230. In an example, air inlet 532 may be located in bottom surface 230 below cooling fan 522. Similarly, air inlet 534 may be located in bottom surface 230 below cooling fan 524. Air inlets 532 and 534 may enable cooling fans 522 and 524 to pull ambient air into information handling system 100. In an example, cooling fan 522 is not sealed to air inlet 532, and cooling fan 524 is not sealed to air inlet 534. In certain examples, additional air inlets may be anywhere in non-pressurized area 204 including, but not limited to, the front, the sides, the top/keyboard, or the like of base portion 102.

In an example, cooling fan 522 may pull ambient air through air inlet 532 and provide the ambient air directly into pressurized area 202. For example, cooling fan 522 may provide airflows 542 into pressurized 202 and across PCBA 510. In an example, airflow 542 may be in a direction toward socketed memory 550 of PCBA 510. Cooling fan 524 may pull ambient air through air inlet 534 and provide the ambient air directly into pressurized area 202. For example, cooling fan 524 may provide airflow 544 into pressurized 202 and across PCBA 510 in the same direction as airflow 542 from cooling fan 522. In an example, sealing component 506 may prevent airflows 542 and 544 from being recirculated from pressurized area 202 to non-pressurized 204.

In certain examples, as airflows 542 and 544 travel across PCBA 510 and heat removal plate 512, heat may be removed from a CPU and other components on PCBA 510. In an example, the heat may be transferred from heat removal plate 512 to heat exchangers 516 via heat pipes 514. Airflows 542 and 544 may travel through heat exchangers 516 and out of pressurized area 202 via one or more air outlets. In certain examples, air outlets of pressurized area 202 may be located at different locations, such as a back wall, side walls, a top surface, bottom surface 230, or the like.

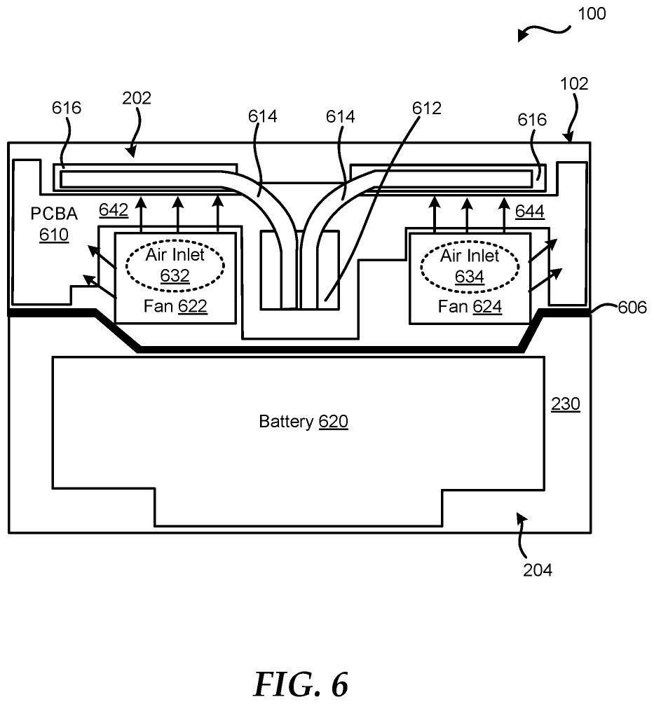

FIG. 6 illustrates information handling system 100 with a pressurized cooling fan hyperbaric thermal architecture according to at least one embodiment of the present disclosure. Information handling system 100 includes pressurized area 202, non-pressurized area 204, and a sealing component 606. Within pressurized area 202, information handling system 100 further includes a PCBA 610, a heat removal plate 612, heat pipes 614, heat exchangers 616, and cooling fans 622 and 624. Within non-pressurized area 204, information handling system 100 further includes a battery 620. Information handling system 100 may include additional components without varying from the scope of this disclosure.

In an example, battery 620 may be any suitable shape. In certain examples, sealing component 606 may create a seal in base portion 102 between pressurized area 202 and non-pressurized 204. In certain examples, sealing component 606 may seal with a chassis structural wall to create a division between pressurized area 202 and non-pressurized area 204. In an example, sealing component 606 may be any suitable component, such as a gasket that is formed from foam covered with mylar. In certain examples, additional sealing components may be utilized to seal around I/O connectors of PCBA 610 to further create pressurized area 202.

In an example, base portion 102 also includes bottom surface 230 that extends below both pressurized area 202 and non-pressurized area 204. In certain examples, information handling system 100 in the pressurized cooling fan hyperbaric thermal architecture includes air inlets 632 and 634 within bottom surface 230 of pressurized area 204. In an example, air inlet 632 may be located in bottom surface 230 below cooling fan 622. Similarly, air inlet 634 may be located in bottom surface 230 below cooling fan 624. Air inlets 632 and 634 may enable cooling fans 622 and 624 to pull ambient air into information handling system 100.

In an example, cooling fan 622 may pull ambient air through air inlet 632 and provide the ambient air directly into pressurized area 202. For example, cooling fan 622 may provide airflows 642 into pressurized 202 and across PCBA 610. Cooling fan 624 may pull ambient air through air inlet 634 and provide the ambient air directly into pressurized area 202. In an example, sealing component 606 may prevent airflows 642 and 644 from being recirculated from pressurized area 202 to non-pressurized 204.

In certain examples, as airflows 642 and 644 travel across PCBA 610 and heat removal plate 612, heat may be removed from a CPU and other components on PCBA 610. In an example, the heat may be transferred from heat removal plate 612 to heat exchangers 616 via heat pipes 614. Airflows 642 and 644 may travel through heat exchangers 616 and out of pressurized area 202 via one or more air outlets. In certain examples, air outlets of pressurized area 202 may be located at different locations, such as a back wall, side walls, a top surface, bottom surface 230, or the like.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. An information handling system comprising:
a pressurized zone;
a non-pressurized zone, wherein the pressurized and non-pressurized zones combine to form a hyperbaric thermal architecture for the information handling system;
a printed circuit board assembly (PCBA) located within the pressurized zone;
a first cooling fan located within the non-pressurized zone, wherein the first cooling fan provides an airflow into the pressurized zone and across the PCBA; and
a sealing component located along an intersection of the pressurized zone and the non-pressurized zone, wherein the sealing component creates the hyperbaric thermal architecture between the pressurized and non-pressurized zones, wherein a portion of the first cooling fan is in physical communication with the sealing component.

2. The information handling system of claim 1, further comprising:
a heat removal plate in physical communication with the PCBA;
a heat exchanger; and
a heat pipe extending between the heat removal plate and the heat exchanger, wherein the airflow from the first cooling fan causes hot air to be expelled from the pressurized zone through the heat exchanger.

3. The information handling system of claim 1, further comprising a battery located within the non-pressurized zone, wherein the first cooling fan is positioned between the battery and the PCBA.

4. The information handling system of claim 1, further comprising: an air inlet located within one of a plurality of locations, wherein the plurality of locations includes a bottom surface of a base portion, a front surface of the base portion, a side of the base portion, and a keyboard on the information handling system, wherein the first cooling fan pulls ambient air through the air inlet.

5. The information handling system of claim 4, wherein the first cooling fan is not sealed to the air inlet.

6. The information handling system of claim 1, wherein the sealing component is in a first shape when the PCBA has a first configuration, and the sealing component is in a second shape when the PCBA has a second configuration.

7. The information handling system of claim 6, wherein the first configuration is a memory on chip configuration, and the second configuration is a socketed memory configuration.

8. The information handling system of claim 6, wherein the first shape of the sealing component is a straight line extending laterally across the information handling system.

9. The information handling system of claim 1, further comprising: a second cooling fan located within the non-pressurized zone, wherein the second cooling fan provides a second airflow into the pressurized zone and across a different section of the PCBA as compared to the airflow provided by the first cooling fan.

10. The information handling system of claim 9, wherein the first cooling fan is located along a first edge of the non-pressurized zone and the second cooling fan is located along a second edge of the non-pressurized zone.

11. The information handling system of claim 9, wherein the second cooling fan further provides a third airflow, wherein the airflow from the first cooling fan is in a first direction, the second airflow from the second cooling fan is in the first direction, and the third airflow from the second cooling fan is in a second direction.

12. An information handling system comprising:
a pressurized zone and a non-pressurized zone that combine to form a hyperbaric thermal architecture for the information handling system;
a printed circuit board assembly (PCBA) located within the pressurized zone;
a first cooling fan located within the non-pressurized zone, wherein the first cooling fan provides an airflow into the pressurized zone and across the PCBA;
a sealing component located along an intersection of the pressurized zone and the non-pressurized zone, wherein the sealing component creates the hyperbaric thermal architecture between the pressurized and non-pressurized zones, wherein a portion of the first cooling fan is in physical communication with the sealing component;
a battery located within the non-pressurized zone, wherein the first cooling fan is positioned between the battery and the PCBA; and
an air inlet located within a bottom surface of a base portion, wherein the first cooling fan pulls ambient air through the air inlet.

13. The information handling system of claim 12, further comprising:
a heat removal plate in physical communication with the PCBA;
a heat exchanger; and
a heat pipe extending between the heat removal plate and the heat exchanger, wherein the airflow from the first cooling fan causes hot air to be expelled from the pressurized zone through the heat exchanger.

14. The information handling system of claim 12, wherein the sealing component is in a first shape when the PCBA has a first configuration, and the sealing component is in a second shape when the PCBA has a second configuration.

15. The information handling system of claim 14, wherein the first configuration is a memory on chip configuration, and the second configuration is a socketed memory configuration.

16. The information handling system of claim 12, further comprising: a second cooling fan located within the non-pressurized zone, wherein the second cooling fan provides a second airflow into the pressurized zone and across a different section of the PCBA as compared to the airflow provided by the first cooling fan.

17. The information handling system of claim 16, wherein the first cooling fan is located along a first edge of the non-pressurized zone and the second cooling fan is located along a second edge of the non-pressurized zone.

18. The information handling system of claim 16, wherein the second cooling fan further provides a third airflow, wherein the airflow from the first cooling fan is in a first direction, the second airflow from the second cooling fan is in the first direction, and the third airflow from the second cooling fan is in a second direction.

19. An information handling system comprising:
a pressurized zone and a non-pressurized zone that form a hyperbaric thermal architecture for the information handling system;
a printed circuit board assembly (PCBA) located within the pressurized zone;
a first cooling fan located within the non-pressurized zone, wherein the first cooling fan provides an airflow into the pressurized zone and across the PCBA;
a sealing component located along an intersection of the pressurized zone and the non-pressurized zone, wherein the sealing component creates the hyperbaric thermal architecture between the pressurized and non-pressurized zones, wherein a portion of the first cooling fan is in physical communication with the sealing component, wherein the sealing component is in a first shape when the PCBA has a first configuration, and the sealing component is in a second shape when the PCBA has a second configuration;
a battery located within the non-pressurized zone, wherein the first cooling fan is positioned between the battery and the PCBA;
an air inlet located within a bottom surface of a base portion, wherein the first cooling fan pulls ambient air through the air inlet;
a heat removal plate in physical communication with the PCBA;
a heat exchanger; and
a heat pipe extending between the heat removal plate and the heat exchanger, wherein the airflow from the first cooling fan causes hot air to be expelled from the pressurized zone through the heat exchanger.

20. The information handling system of claim 19, further comprising: a second cooling fan located within the non-pressurized zone, wherein the second cooling fan provides a second airflow into the pressurized zone and across a different section of the PCBA as compared to the airflow provided by the first cooling fan.
